(19) United States
(12) Patent Application Publication
(10) Pub. No.: US 2019/0323127 A1
(43) Pub. Date: Oct. 24, 2019

(54) TEXTURING AND PLATING NICKEL ON ALUMINUM PROCESS CHAMBER COMPONENTS

(71) Applicant: Applied Materials, Inc., Santa Clara, CA (US)

(72) Inventors: Laksheswar Kalita, San Jose, CA (US); Soonam Park, Sunnyvale, CA (US); Dmitry Lubomirsky, Cupertino, CA (US)

(73) Assignee: Applied Materials, Inc., Santa Clara, CA (US)

(21) Appl. No.: 15/957,076

(22) Filed: Apr. 19, 2018

(51) Int. Cl. C23C 18/18; C23C 18/32; C23C 18/16; B32B 15/01; C25F 3/04

(52) U.S. Cl. CPC C23C 18/1848; C23C 18/32; C23C 18/1637; C25F 3/04; C23C 18/1692; B32B 15/017; C23C 18/1603

(57) ABSTRACT

Systems and methods may be used to produce coated components. Exemplary chamber components may include an aluminum plate defining a plurality of apertures. The plate may include a nickel coating on a textured aluminum plate to provide for adhesion. Implementing the present technology, the nickel coating may be firmly affixed with or without first applying an intermediate adhesion layer. Deleterious components from the intermediate adhesion layer (if present) may not contaminate substrates as readily as a consequence of the texturing of the aluminum plate. The contamination from the intermediate adhesion layer is undesirable and may electrically compromise semiconductor devices during processing.

### TECHNICAL FIELD

The present technology relates to semiconductor systems, processes, and equipment. More specifically, the present technology relates to systems including or forming coatings on chamber components.

### BACKGROUND

Integrated circuits are made possible by processes which produce intricately patterned material layers on semiconductor wafer and substrate surfaces. Producing patterned material on a substrate requires controlled methods for removal of exposed material. Chemical etching is used for a variety of purposes including transferring a pattern in photoresist into underlying layers, thinning layers, or thinning lateral dimensions of features already present on the surface. Often it is desirable to have an etch process that etches one material faster than another facilitating, for example, a pattern transfer process. Such an etch process is said to be selective to the first material. As a result of the diversity of materials, circuits, and processes, etch processes have been developed with a selectivity towards a variety of materials.

Etch processes may be termed wet or dry based on the materials used in the process. A wet HF etch preferentially removes silicon oxide over other dielectrics and materials. However, wet processes may have difficulty penetrating some constrained trenches and also may sometimes deform the remaining material. Dry etches produced in local plasmas formed within the substrate processing region can penetrate more constrained trenches and exhibit less deformation of delicate remaining structures. However, local plasmas may damage the substrate through the production of electric arcs as they discharge. Local plasmas, as well as plasma effluents may damage chamber components as well.

Thus, there is a need for improved systems and methods that can be used to produce high quality devices and structures. These and other needs are addressed by the present technology.

### SUMMARY

Systems and methods may be used to produce coated components. Exemplary chamber components may include an aluminum plate defining a plurality of apertures. The plate may include a nickel coating on a textured aluminum plate to improve purity and adhesion while removing the requirement for conventional adhesion methods. Implementing the present technology, the nickel coating may be firmly affixed with or without first applying an intermediate adhesion layer. Deleterious components from the intermediate adhesion layer (if present) may not contaminate substrates as readily as a consequence of the texturing of the aluminum plate. The contamination from the intermediate adhesion layer is undesirable and may electrically compromise semiconductor devices during processing.

Exemplary methods for coating aluminum chamber components includes coating a showerhead. The showerhead comprises through-holes extending from a top of the showerhead to a bottom of the showerhead. The methods include removing aluminum oxide from the showerhead. Removing the aluminum oxide exposes aluminum portions of the showerhead. The methods further include electrochemically anchoring the aluminum portions of the showerhead by exposing the showerhead to an electrochemically anchoring chemical. The methods further include forming a nickel layer on the aluminum portions.

In some embodiments, the electrochemically anchoring chemical may include at least one of hydrochloric acid, sulfuric acid, oxalic acid, propionic acid, succinic acid, glycolic acid, or an organic acid. Exposing the showerhead to the electrochemically anchoring chemical may include submerging the showerhead in a liquid bath. A temperature of the liquid bath may be between −20° C. and 120° C. The nickel layer may consist of nickel or may consist of nickel and phosphorus. The methods may further include forming an adhesion layer after electrochemically anchoring the aluminum portions and before forming the nickel layer. The thickness of the adhesion layer may be less than 5 μm. No adhesion layer may be included between the aluminum portions and the nickel layer in some cases.

The present technology may also encompass additional coating methods. The additional methods may include coating a component for use in a semiconductor processing chamber. The methods include texturing an exposed surface of the component. The component defines a plurality of apertures including a taper extending at least partially through a first section of each aperture of the plurality of apertures. The taper is characterized by an angle of taper through the first section of each aperture of the plurality of apertures. The methods further include applying a protective coating onto the component. The protective coating may include nickel and phosphorus.

In some embodiments, the exposed surface of the component is aluminum or aluminum oxide. The thickness of the protective coating may be less than 200 μm. Texturing the exposed surface may be performed to a depth of at least 10 nm. The protective coating may include nickel and phosphorus and may include between 3% and 16% phosphorus by weight.

The present technology may also encompass additional coating methods. The additional methods may include methods of coating a showerhead. the methods include removing aluminum oxide from the showerhead. Removing the aluminum oxide exposes aluminum portions of the showerhead and the showerhead comprises apertures extending from a top of the showerhead to a bottom of the showerhead. The methods further include electrochemically anchoring the aluminum portions of the showerhead by exposing the showerhead to an electrochemically anchoring chemical in a liquid bath. The methods further include applying a voltage between the showerhead and an anode, wherein the showerhead and the anode are disposed within the liquid bath. The methods further include texturing the aluminum portions of the showerhead. The methods further include electroless nickel plating a nickel layer onto the aluminum portions of the showerhead. In some embodiments, the voltage may be between 0.1 volts and 500 volts.

Such technology may provide numerous benefits over conventional systems and techniques. For example, coatings according to the present technology may provide protection to chamber components that may limit component degradation and corrosion. Additionally, the coatings may also protect substrates being processed from contamination due to degrading components. The etch selectivity of silicon nitride relative to silicon oxide may also be increased relative to conventional local plasma processes. These and other embodiments, along with many of their advantages and features, are described in more detail in conjunction with the below description and attached figures.

### DESCRIPTION OF THE DRAWINGS

A further understanding of the nature and advantages of the embodiments may be realized by reference to the remaining portions of the specification and the drawings.

FIG. 1 shows a top plan view of one embodiment of an exemplary processing system according to embodiments of the present technology.

FIG. 2 shows a schematic cross-sectional view of an exemplary processing chamber according to some embodiments of the present technology.

FIG. 3 shows a schematic cross-sectional view of an exemplary processing chamber according to some embodiments of the present technology.

FIGS. 4A-4E illustrate schematic cross-sectional views of exemplary apertures that may be formed in a chamber component according to some embodiments of the present technology.

FIG. 5 illustrates exemplary operations in methods according to some embodiments of the present technology.

FIG. 6 illustrates exemplary operations in methods according to some embodiments of the present technology.

FIGS. 7A, 7B, and 7C illustrate schematic cross-sectional views of exemplary protective coatings that may be formed on a chamber component according to some embodiments of the present technology.

FIGS. 8A, 8B, and 8D illustrate schematic cross-sectional views of exemplary protective coatings that may be formed on a chamber component according to some embodiments of the present technology.

Several of the figures are included as schematics. It is to be understood that the figures are for illustrative purposes, and are not to be considered of scale unless specifically stated to be of scale. Additionally, as schematics, the figures are provided to aid comprehension and may not include all aspects or information compared to realistic representations, and may include superfluous or exaggerated material for illustrative purposes.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the letter.

### DETAILED DESCRIPTION

The present technology includes systems and components for semiconductor processing of small pitch features. As line pitch is reduced, standard lithography processes may be limited, and alternative mechanisms may be used in patterning. Conventional technologies have struggled with these minimal patterning and removal operations, especially when exposed materials on a substrate may include many different features and materials, some to be etched and some to be retained. Additionally, as feature sizes continue to shrink the tolerance to microcontamination (particles and elemental contamination) may reduce as well.

Atomic layer etching is a process that utilizes a multiple-operation process of damaging or modifying a material surface followed by an etching or removal operation. The etching operation may be performed at chamber conditions allowing the modified material to be removed, but limiting interaction with unmodified materials. This process may then be cycled any number of times to etch additional materials. Some chambers available can perform both operations within a single chamber. The modification may be performed with a bombardment operation at the substrate level, followed by a remote plasma operation to enhance etchant precursors capable of removing only the modified materials.

During the modification operation, a wafer-level plasma may be formed within the processing region. For example, a bias plasma may be formed from the substrate support, which may form a plasma of a precursor within a processing region. The plasma may direct ions to the surface of the substrate to leverage higher ion density. The bias plasma may be a capacitively-coupled plasma, which may produce plasma effluents throughout the processing region with a high plasma potential. An inductively-coupled plasma formed above the substrate may provide a more controlled delivery of plasma effluents, in contrast to the capacitively-coupled plasma which may develop plasma species that sputter chamber components. Sputtering may damage chamber components and may deposit particles and undesirable elemental contamination on the substrate being processed.

During the removal or etching operation, an additional plasma process may be performed in which plasma effluents are produced in a remote portion of the chamber, or in a fluidly coupled external plasma unit. These effluents may be delivered through the chamber to interact with the substrate under process. During these processes, chamber components may be contacted by one or both of the modifying plasma effluents or the removal plasma effluents. The modifying plasma effluents may gradually remove material from chamber components, redeposit the material onto the substrate.

Conventional technologies have struggled to limit redeposition from chamber components onto the substrate. Limiting redeposition conventionally relies on more frequent preventative maintenance replacement procedures and shorts lifespan of chamber components. The shortened lifespan of chamber components increases costs and increases system downtime. Nickel coatings have been used to coat aluminum and aluminum oxide chamber components due to the relatively inert nature of the nickel surface and its physical resilience. However, an adhesion-promoting layer is included beneath the nickel to improve nickel retention during harsh processes such as etch processes. Unfortunately, well-performing conventional adhesion layers include undesirable contaminants (e.g. zinc, tin and lead) whose redeposition onto the substrate may result in yield loss and/or device performance degradation. For example, zinc has been found on processed substrates despite the zinc layer being located beneath the nickel layer. The zinc may be spread throughout the nickel during deposition or may be uncovered in certain high-exposure portions of the processing chamber. Implementing the protective coatings as outlined herein is especially beneficial for harsh etch processes which may chemically and/or physically erode a conventional coating and redistribute contaminants onto a substrate.

The present technology overcomes these issues by adhering the protective coating (e.g. a nickel layer) only after texturizing the surface of the chamber component to enable anchoring sites along the surface. The improved adhesion of the protective coating may prevent peeling of the protective layer, may allow reduction or elimination of an adhesion layer, and may increase the growth rate of the protective coating (e.g. by electroless nickel plating). The techniques presented herein may increase mechanical strength and erosion resistance of the protective coating as well. Additionally, the present technology provides improved coverage of chamber components with protective coatings, which improves lifetime and stability of the chamber components and their protective coatings.

Although the remaining disclosure will routinely identify specific etching processes utilizing the disclosed technology, it will be readily understood that the systems and methods are equally applicable to deposition and cleaning processes as may occur in the described chambers and also include plasma or other reactive materials. Accordingly, the technology should not be considered to be so limited as for use with etching processes alone.

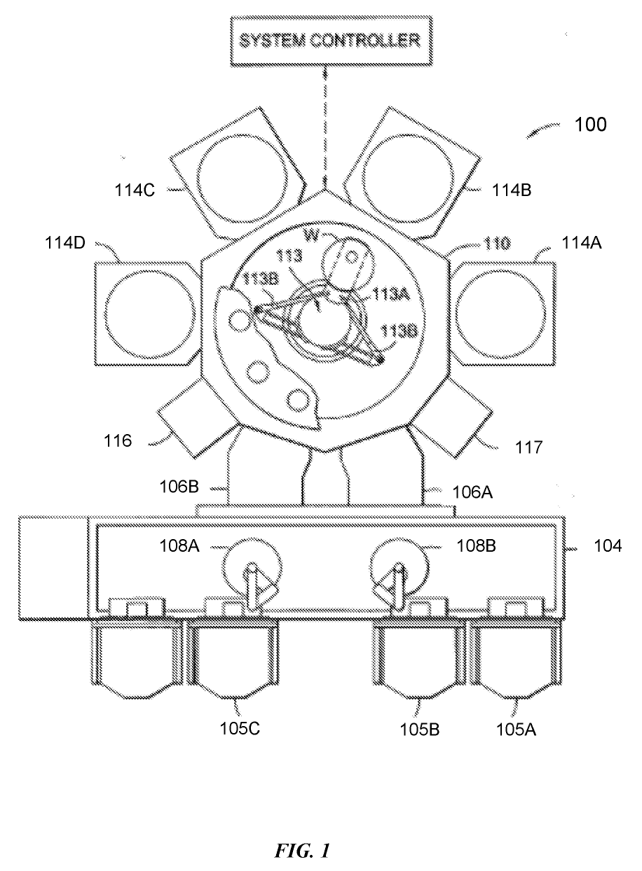

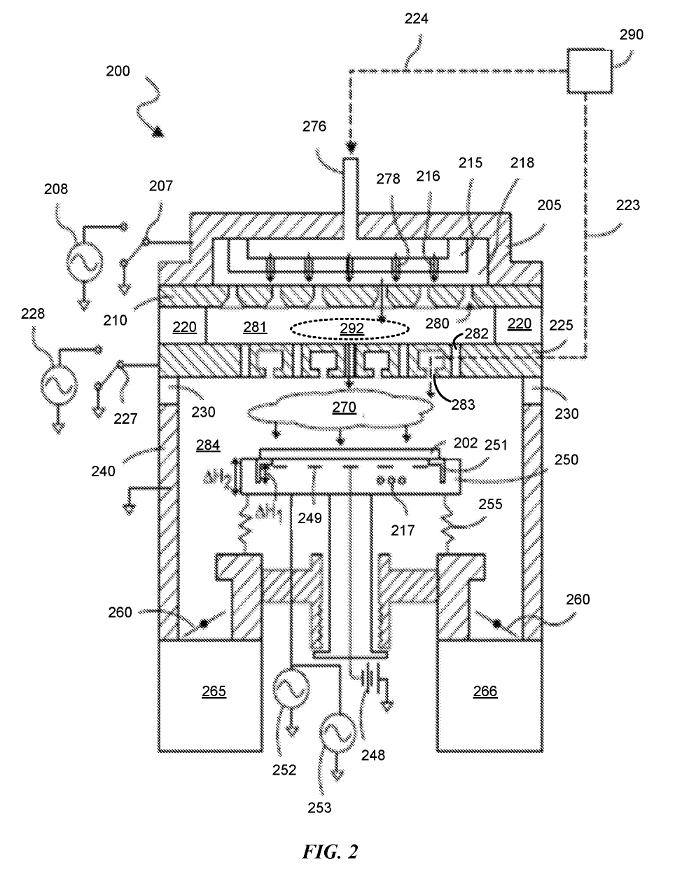

FIG. 1 shows a top plan view of one embodiment of a processing system 100 of deposition, etching, baking, and curing chambers according to embodiments. The processing tool 100 depicted in FIG. 1 may contain a plurality of process chambers, 114A-D, a transfer chamber 110, a service chamber 116, an integrated metrology chamber 117, and a pair of load lock chambers 106A-B. The process chambers may include structures or components similar to those described in relation to FIG. 2, as well as additional processing chambers.

To transport substrates among the chambers, the transfer chamber 110 may contain a robotic transport mechanism 113. The transport mechanism 113 may have a pair of substrate transport blades 113A attached to the distal ends of extendible arms 113B, respectively. The blades 113A may be used for carrying individual substrates to and from the process chambers. In operation, one of the substrate transport blades such as blade 113A of the transport mechanism 113 may retrieve a substrate W from one of the load lock chambers such as chambers 106A-B and carry substrate W to a first stage of processing, for example, an etching process as described below in chambers 114A-D. If the chamber is occupied, the robot may wait until the processing is complete and then remove the processed substrate from the chamber with one blade 113A and may insert a new substrate with a second blade (not shown). Once the substrate is processed, it may then be moved to a second stage of processing. For each move, the transport mechanism 113 generally may have one blade carrying a substrate and one blade empty to execute a substrate exchange. The transport mechanism 113 may wait at each chamber until an exchange can be accomplished.

Once processing is complete within the process chambers, the transport mechanism 113 may move the substrate W from the last process chamber and transport the substrate W to a cassette within the load lock chambers 106A-B. From the load lock chambers 106A-B, the substrate may move into a factory interface 104. The factory interface 104 generally may operate to transfer substrates between pod loaders 105A-D in an atmospheric pressure clean environment and the load lock chambers 106A-B. The clean environment in factory interface 104 may be generally provided through air filtration processes, such as HEPA filtration, for example. Factory interface 104 may also include a substrate orienter/aligner (not shown) that may be used to properly align the substrates prior to processing. At least one substrate robot, such as robots 108A-B, may be positioned in factory interface 104 to transport substrates between various positions/locations within factory interface 104 and to other locations in communication therewith. Robots 108A-B may be configured to travel along a track system within interface 104 from a first end to a second end of the factory interface 104.

The processing system 100 may further include an integrated metrology chamber 117 to provide control signals, which may provide adaptive control over any of the processes being performed in the processing chambers. The integrated metrology chamber 117 may include any of a variety of metrological devices to measure various film properties, such as thickness, roughness, composition, and the metrology devices may further be capable of characterizing grating parameters such as critical dimensions, sidewall angle, and feature height under vacuum in an automated manner.

FIG. 2 is a cross-sectional view of an exemplary processing chamber 200 according to the present technology. Chamber 200 may be used, for example, in one or more of the processing chamber sections 114 of the system 100 previously discussed The etch chamber 200 may include a first capacitively-coupled plasma source to implement an ion milling operation and a second capacitively-coupled plasma source to implement an etching operation and to implement an optional deposition operation. The ion milling operation may also be called a modification operation. The chamber 200 may include grounded chamber walls 240 surrounding a chuck 250. In embodiments, the chuck 250 may be an electrostatic chuck that clamps the substrate 202 to a top surface of the chuck 250 during processing, though other clamping mechanisms as would be known may also be utilized. The chuck 250 may include an embedded heat exchanger coil 217. In the exemplary embodiment, the heat exchanger coil 217 includes one or more heat transfer fluid channels through which heat transfer fluid, such as an ethylene glycol/water mix, may be passed to control the temperature of the chuck 250 and ultimately the temperature of the substrate 202.

The chuck 250 may include a mesh 249 coupled to a high voltage DC supply 248 so that the mesh 249 may carry a DC bias potential to implement the electrostatic clamping of the substrate 202. The chuck 250 may be coupled with a first RF power source and in one such embodiment, the mesh 249 may be coupled with the first RF power source so that both the DC voltage offset and the RF voltage potentials are coupled across a thin dielectric layer on the top surface of the chuck 250. In the illustrative embodiment, the first RF power source may include a first RF generator 252 and a second RF generator 253. The RF generators 252, 253 may operate at any industrially utilized frequency, however in the exemplary embodiment the RF generator 252 may operate at 60 MHz to provide advantageous directionality. Where a second RF generator 253 is also provided, the exemplary frequency may be 2 MHz.

The chuck 250 may be RF powered and an RF return path may be provided by a first showerhead 225. The first showerhead 225 may be disposed above the chuck to distribute a first feed gas into a first chamber region 284 defined by the first showerhead 225 and the chamber wall 240. As such, the chuck 250 and the first showerhead 225 form a first RF coupled electrode pair to capacitively energize a first plasma 270 of a first feed gas within a first chamber region 284. A DC plasma bias, or RF bias, resulting from capacitive coupling of the RF powered chuck may generate an ion flux from the first plasma 270 to the substrate 202, e.g., Ar ions where the first feed gas is Ar, to provide an ion milling plasma. The first showerhead 225 may be grounded or alternately coupled with an RF source 228 having one or more generators operable at a frequency other than that of the chuck 250, e.g., 13.56 MHz or 60 MHz. In the illustrated embodiment the first showerhead 225 may be selectably coupled to ground or the RF source 228 through the relay 227 which may be automatically controlled during the etch process, for example by a controller (not shown). In disclosed embodiments, chamber 200 may not include showerhead 225 or dielectric spacer 220, and may instead include only baffle 215 and showerhead 210 described further below.

As further illustrated in the figure, the etch chamber 200 may include a pump stack capable of high throughput at low process pressures. In embodiments, at least one turbo molecular pump 265, 266 may be coupled with the first chamber region 284 through one or more gate valves 260 and disposed below the chuck 250, opposite the first showerhead 225. The turbo molecular pumps 265, 266 may be any commercially available pumps having suitable throughput and more particularly may be sized appropriately to maintain process pressures below or about 10 mTorr or below or about 5 mTorr at the desired flow rate of the first feed gas, e.g., 50 to 500 sccm of Ar where argon is the first feed gas. In the embodiment illustrated, the chuck 250 may form part of a pedestal which is centered between the two turbo pumps 265 and 266. In alternative configurations, chuck 250 may be on a pedestal cantilevered from the chamber wall 240 with a single turbo molecular pump having a center aligned with a center of the chuck 250.

Disposed above the first showerhead 225 may be a second showerhead 210. In one embodiment, during processing, the first feed gas source (e.g. Argon) delivered from gas distribution system 290 may be coupled with a gas inlet 276, and the first feed gas flowed through a plurality of apertures 280 extending through second showerhead 210, into the second chamber region 281, and through a plurality of apertures 282 extending through the first showerhead 225 into the first chamber region 284. An additional flow distributor or baffle 215 having apertures 278 may further distribute a first feed gas flow 216 across the diameter of the etch chamber 200 through a distribution region 218. In an alternate embodiment, the first feed gas may be flowed directly into the first chamber region 284 via apertures 283 which are isolated from the second chamber region 281 as denoted by dashed line 223.

Chamber 200 may additionally be reconfigured from the state illustrated to perform an etching operation. A secondary electrode 205 may be disposed above the first showerhead 225 with a second chamber region 281 there between. The secondary electrode 205 may further form a lid or top plate of the etch chamber 200. The secondary electrode 205 and the first showerhead 225 may be electrically isolated by a dielectric ring 220 and form a second RF coupled electrode pair to capacitively discharge a second plasma 292 of a second feed gas within the second chamber region 281. Advantageously, the second plasma 292 may not provide a significant RF bias potential on the chuck 250. At least one electrode of the second RF coupled electrode pair may be coupled with an RF source for energizing an etching plasma. The secondary electrode 205 may be electrically coupled with the second showerhead 210. In an exemplary embodiment, the first showerhead 225 may be coupled with a ground plane or floating and may be coupled to ground through a relay 227 allowing the first showerhead 225 to also be powered by the RF power source 228 during the ion milling mode of operation. Where the first showerhead 225 is grounded, an RF power source 208, having one or more RF generators operating at 13.56 MHz or 60 MHz, for example, may be coupled with the secondary electrode 205 through a relay 207 which may allow the secondary electrode 205 to also be grounded during other operational modes, such as during an ion milling operation, although the secondary electrode 205 may also be left floating if the first showerhead 225 is powered.

A second feed gas source, such as nitrogen trifluoride, C₂F₆, CF₄, SF₆, and a hydrogen source, such as ammonia and/or C₂H₂, may be delivered from gas distribution system 290, and coupled with the gas inlet 276 such as via dashed line 224. In this mode, the second feed gas may flow through the second showerhead 210 and may be energized in the second chamber region 281. Reactive species may then pass into the first chamber region 284 to react with the substrate 202. As further illustrated, for embodiments where the first showerhead 225 is a multi-channel showerhead, one or more feed gases may be provided to react with the reactive species generated by the second plasma 292. In one such embodiment, a water source may be coupled with the plurality of apertures 283. Additional configurations may also be based on the general illustration provided, but with various components reconfigured. For example, flow distributor or baffle 215 may be a plate similar to the second showerhead 210, and may be positioned between the secondary electrode 205 and the second showerhead 210. As any of these plates may operate as an electrode in various configurations for producing plasma, one or more annular or other shaped spacer may be positioned between one or more of these components, similar to dielectric ring 220. Second showerhead 210 may also operate as an ion suppression plate in embodiments, and may be configured to reduce, limit, or suppress the flow of ionic species through the second showerhead 210, while still allowing the flow of neutral and radical species. One or more additional showerheads or distributors may be included in the chamber between first showerhead 225 and chuck 250. Such a showerhead may take the shape or structure of any of the distribution plates or structures previously described. Also, in embodiments a remote plasma unit (not shown) may be coupled with the gas inlet to provide plasma effluents to the chamber for use in various processes.

In an embodiment, the chuck 250 may be movable along the distance H2 in a direction normal to the first showerhead 225. The chuck 250 may be on an actuated mechanism surrounded by a bellows 255, or the like, to allow the chuck 250 to move closer to or farther from the first showerhead 225 as a means of controlling heat transfer between the chuck 250 and the first showerhead 225, which may be at an elevated temperature of 80° C.-150° C., 150° C.-240° C. or more. As such, an etch process may be implemented by moving the chuck 250 between first and second predetermined positions relative to the first showerhead 225. Alternatively, the chuck 250 may include a lifter 251 to elevate the substrate 202 off a top surface of the chuck 250 by distance H1 to control heating by the first showerhead 225 during the etch process. In other embodiments, where the etch process is performed at a fixed temperature such as between 90-110° C., 110-170° C., or more, for example, chuck displacement mechanisms may be avoided. A system controller (not shown) may alternately energize the first and second plasmas 270 and 292 during the etching process by alternately powering the first and second RF coupled electrode pairs automatically.

The chamber 200 may also be reconfigured to perform a deposition operation. A plasma 292 may be generated in the second chamber region 281 by an RF discharge which may be implemented in any of the manners described for the second plasma 292. Where the first showerhead 225 is powered to generate the plasma 292 during a deposition, the first showerhead 225 may be isolated from a grounded chamber wall 240 by a dielectric spacer 230 so as to be electrically floating relative to the chamber wall. In the exemplary embodiment, an oxidizer feed gas source, such as molecular oxygen, may be delivered from gas distribution system 290, and coupled with the gas inlet 276. In embodiments where the first showerhead 225 is a multi-channel showerhead, any silicon-containing precursor, such as OMCTS for example, may be delivered from gas distribution system 290, and directed into the first chamber region 284 to react with reactive species passing through the first showerhead 225 from the plasma 292. Alternatively the silicon-containing precursor may also be flowed through the gas inlet 276 along with the oxidizer. Chamber 200 is included as a general chamber configuration that may be utilized for various operations discussed in reference to the present technology. The chamber is not to be considered limiting to the technology, but instead to aid in understanding of the processes described. Several other chambers known in the art or being developed may be utilized with the present technology including any chamber produced by Applied Materials Inc. of Santa Clara, Calif., or any chamber that may perform the techniques described in more detail below.

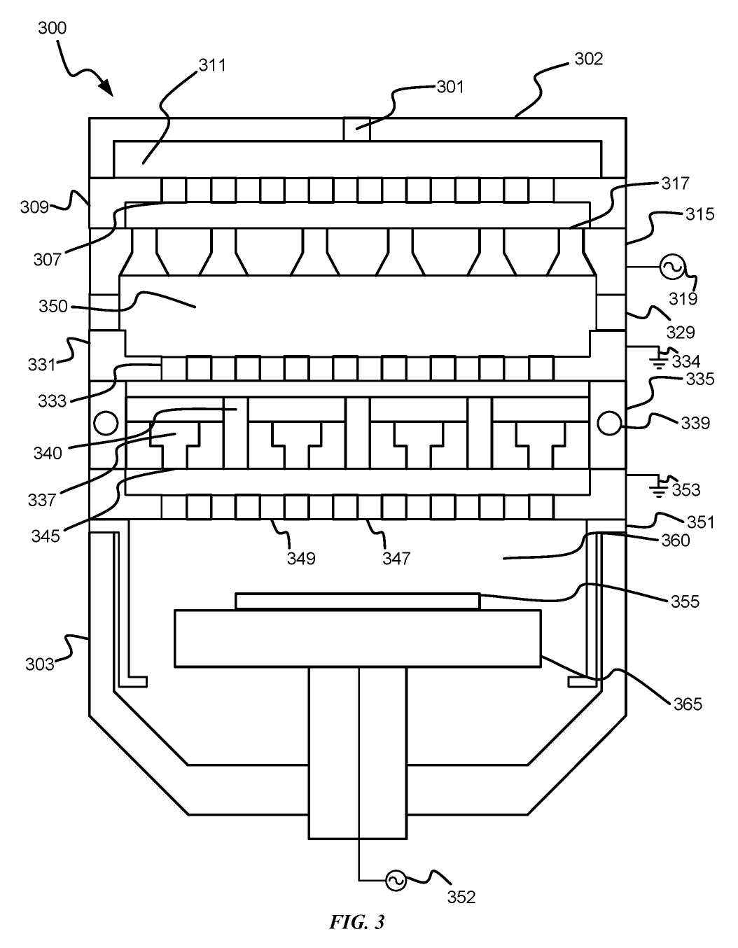

FIG. 3 shows a partial schematic view of a processing chamber 300 according to embodiments of the present technology. FIG. 3 may include one or more components discussed above with regard to FIG. 2, and may illustrate further details relating to that chamber, as well as additional embodiments of chambers that may include one or more components similar to those illustrated. The chamber 300 may be used to perform semiconductor processing operations including modification and etching as previously described.

The chamber 300 may be configured to house a semiconductor substrate 355 in a processing region 360 of the chamber. The chamber housing 303 may at least partially define an interior region of the chamber. For example, the chamber housing 303 may include lid 302, and may at least partially include any of the other plates or components illustrated in the figure. For example, the chamber components may be included as a series of stacked components with each component at least partially defining a portion of chamber housing 303. The substrate 355 may be located on a pedestal 365 as shown. Processing chamber 300 may include a remote plasma unit (not shown) coupled with inlet 301. In other embodiments, the system may not include a remote plasma unit, and may be configured to receive precursors directly through inlet 301, which may include an inlet assembly for one or more precursors to be distributed to the chamber 300.

With or without a remote plasma unit, the system may be configured to receive precursors or other fluids through inlet 301, which may provide access to a mixing region 311 of the processing chamber. The mixing region 311 may be separate from and fluidly coupled with the processing region 360 of the chamber. The mixing region 311 may be at least partially defined by a top of the chamber 300, such as chamber lid 302 or lid assembly, which may include an inlet assembly for one or more precursors, and a distribution device, such as showerhead or faceplate 309 below. Faceplate 309 may include a plurality of channels or apertures 307 that may be positioned and/or shaped to affect the distribution and/or residence time of the precursors in the mixing region 311 before proceeding through the chamber.

The chamber 300 may include one or more of a series of components that may optionally be included in disclosed embodiments. For example although faceplate 309 is described, in some embodiments the chamber may not include such a faceplate. Additionally, in disclosed embodiments, the precursors that are at least partially mixed in mixing region 311 may be directed through the chamber via one or more of the operating pressure of the system, the arrangement of the chamber components, or the flow profile of the precursors.

Chamber 300 may additionally include a first showerhead 315. Showerhead 315 may be positioned within the semiconductor processing chamber as illustrated, and may be included or positioned between the lid 302 and the processing region 360. In embodiments, showerhead 315 may be or include a metallic or conductive component that may be a coated, seasoned, or otherwise treated material. Exemplary materials may include metals, including aluminum, stainless steel, or nickel, as well as metal oxides, including aluminum oxide, or any of the materials discussed below. Depending on the precursors being utilized, or the process being performed within the chamber, the showerhead may be any other metal that may provide structural stability as well as conductivity as may be utilized.

Showerhead 315 may define one or more apertures 317 to facilitate uniform distribution of precursors through the showerhead. The apertures 317 may be included in a variety of configurations or patterns, and may be characterized by any number of geometries that may provide precursor distribution as may be desired. Showerhead 315, may be electrically coupled with a power source in embodiments. For example, showerhead 315 may be coupled with an RF source 319 as illustrated. When operated, RF source 319 may provide a current to showerhead 315 allowing a capacitively-coupled plasma (“CCP”) to be formed between the showerhead 315 and a second showerhead 331.

Showerhead 331 may be a second showerhead included within the chamber, and may operate as an additional electrode with showerhead 315. Showerhead 331 may include any of the features or characteristics of showerhead 315 discussed previously. In other embodiments certain features of showerhead 331 may diverge from showerhead 315, such as by defining an aperture profile configured to filter ions from plasma effluents produced in the chamber. For example, showerhead 331 may be coupled with an electrical ground 334, which may allow a plasma to be generated between showerhead 315 and showerhead 331 in embodiments, such as in region 350 defined between the two components. Showerhead 331 may define apertures 333 within the structure to allow precursors or plasma effluents to be delivered to processing region 360.

Chamber 300 optionally may further include a gas distribution assembly 335 within the chamber. In some embodiments, there may be no components between showerhead 331 and processing region 360, and showerhead 331 may allow distribution of precursors or plasma effluents to the processing region 360. The gas distribution assembly 335, which may be similar in aspects to the dual-channel showerheads as previously described, may be located within the chamber above the processing region 360, such as between the processing region 360 and the lid 302, as well as between the processing region 360 and the showerhead 331. The gas distribution assembly 335 may be configured to deliver both a first and a second precursor into the processing region 360 of the chamber. In embodiments, the gas distribution assembly 335 may at least partially divide the interior region of the chamber into a remote region and a processing region in which substrate 355 is positioned.

Although the exemplary system of FIG. 3 includes a dual-channel showerhead, it is understood that alternative distribution assemblies may be utilized that maintain a precursor fluidly isolated from species introduced through inlet 301. For example, a perforated plate and tubes underneath the plate may be utilized, although other configurations may operate with reduced efficiency or not provide as uniform processing as the dual-channel showerhead as described. By utilizing one of the disclosed designs, a precursor may be introduced into the processing region 360 that is not previously excited by a plasma prior to entering the processing region 360, or may be introduced to avoid contacting an additional precursor with which it may react. Although not shown, an additional spacer may be positioned between the showerhead 331 and the gas distribution assembly 335, such as an annular spacer, to isolate the plates from one another. In embodiments in which an additional precursor may not be included, the gas distribution assembly 335 may have a design similar to any of the previously described components, such as any of plates 309, 315, and 331.

In embodiments, gas distribution assembly 335 may include an embedded heater 339, which may include a resistive heater or a temperature controlled fluid, for example. The gas distribution assembly 335 may include an upper plate and a lower plate. The plates may be coupled with one another to define a volume 337 between the plates. The coupling of the plates may be such as to provide first fluid channels 340 through the upper and lower plates, and second fluid channels 345 through the lower plate. The formed channels may be configured to provide fluid access from the volume 337 through the lower plate, and the first fluid channels 340 may be fluidly isolated from the volume 337 between the plates and the second fluid channels 345. The volume 337 may be fluidly accessible through a side of the gas distribution assembly 335, such as channel 223 as previously discussed. The channel may be coupled with an access in the chamber separate from the inlet 301 of the chamber 300.

An additional optional component that may or may not be included in the chamber 300 is faceplate 347, which may also be a dielectric, such as quartz, as well as aluminum or another conductive material, including any of the materials discussed above for showerheads 315, 331. Faceplate 347 may provide similar functionality, and include similar characteristics, as showerheads 315, 331, and may be used in an ion milling or ion etching operation as explained above. For example, when a conductive material, faceplate 347 may be coupled to an electrode, such as coupled with a ground source 353, which in combination with RF source 352 may be used to produce a bias plasma for performing modification operations (e.g. ion milling). In other embodiments the electrical couplings may be reversed. Faceplate 347 may include apertures 349 defined through the structure of the faceplate. Any of the faceplates may have aperture characteristics, patterns, or sizing as discussed throughout this application. The chamber 300 may also include a chamber liner 351, which may protect the walls of the chamber from plasma effluents as well as material deposition, for example. The liner may be or may include a conductive material, and in embodiments may be or include a dielectric material. In some embodiments, the chamber walls or liner may operate as an additional electrical grounding source.

A spacer 329 may be positioned between the first showerhead 315 and the second showerhead 331. The spacer may be a dielectric, and may be quartz or any other dielectric material providing insulation between the two components. In embodiments, spacer 329 may be an annular spacer positioned between the two faceplates and contacting both showerheads. In some embodiments, the plasma processing region 350 may be defined in part between the first showerhead 315 and the second showerhead 331. These components may be at least partially configured to at least partially contain a plasma generated between the first showerhead 315 and the second showerhead 331. In some embodiments, these components may be spaced, positioned, or configured to substantially contain the plasma between the two components.

The showerheads may function to dramatically reduce or substantially eliminate ionically charged species traveling from the plasma generation region(s) to the substrate for some of the processes. During these processes, the electron temperature may be less than 0.5 eV, less than 0.45 eV, less than 0.4 eV, or less than 0.35 eV according to embodiments.

As explained previously, chambers according to some embodiments of the present technology may be used to perform both modification operations in which a bias plasma may be formed in region 360. This operation may be a physical bombardment of structures on a substrate, and may utilize inert or less reactive precursors. Additionally, a reactive etch may be performed by producing reactive plasma effluents in region 350. The precursors may include halogen precursors, which may be configured to remove modified material from a substrate. Accordingly, components of the chamber may be exposed to both chemically reactive plasma effluents, such as fluorine, chlorine, or other halogen-containing effluents, as well as ions produced in the bias plasma used for physical modification. For example, faceplate 347, which may be an additional showerhead, may be exposed to both plasma effluents, such as bias plasma effluents contacting the surface facing the substrate and within apertures, as well as reactive effluents proceeding through apertures 349 before interacting with substrate 355. Other components described above may also be exposed to one or both plasma effluents, including from backstreaming plasma effluents.

The plasma effluents may produce differing effects on the chamber components. For example, ions may be at least partially filtered by showerhead 331 from the chemically reactive plasma effluents produced in region 350. However, the reactive effluents, such as fluorine-containing effluents, for example, may cause corrosion of exposed materials, such as by forming aluminum fluoride. Over time, this process may corrode exposed metallic components, requiring replacement. Additionally, plasma species formed from a bias plasma in region 360 may impact components causing physical damage and sputtering that may erode components over time. Accordingly, any of the described components may be susceptible to chemical corrosion as well as physical erosion from plasma effluents produced within one or more regions of the chamber.

With regard to chamber components, process chambers and substrates, “Top” and “Up” will be used herein to describe portions/directions perpendicularly distal from the substrate plane and further away from the center of mass of the substrate in the perpendicular direction. “Vertical” will be used to describe items aligned in the “Up” direction towards the “Top” or “Bottom”. Other similar terms may be used whose meanings will now be clear. For example, apertures in the various showerheads may be circular as viewed from above.

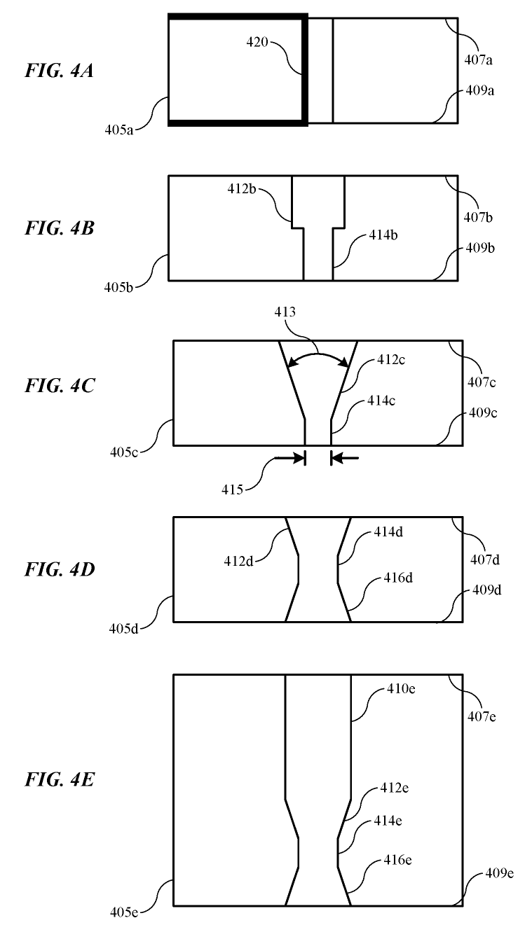

FIGS. 4A-4E illustrate schematic cross-sectional views of exemplary apertures that may be formed in any of the semiconductor chamber components previously discussed according to embodiments of the present technology. The figures provide exemplary views of aperture configurations intended to illustrate possible aperture designs encompassed by embodiments of the present technology. It is to be understood that additional and alternative aperture designs may also be used, and each component may include any number of apertures, such as a plurality of apertures similar to the exemplary aperture of each figure. The apertures are illustrated as extending through an exemplary chamber component 405, which may be an illustration of any of the chamber components previously described, and which may have apertures, including any of the faceplates or showerheads noted above. FIG. 4A illustrates an aperture configuration which may include a straight cylindrical path from a first surface 407a of component 405a to a second surface 409a.

The illustration also includes an exemplary coating on a left side of the component, which may be formed according to embodiments of the present technology. It is to be understood that the coating may be included on all surfaces of the component in embodiments, and is shown as a partial coverage for illustrative purposes. The protective coating 420 may extend conformally through each aperture of the component 405. Of course, the protective coating 420 may cover all exposed surfaces of each component (405a, 405b, 405c, 405d and 405e) and only a portion of component 405a is shown coated for the purposes of illustration. The protective coating 420 may discourage chemical corrosion and physical erosion of the underlying component, including protection against etchants (e.g. halogen-containing effluents) and/or protection against ion bombardment. The protective coating may be or include a nickel coating (e.g. electroless nickel plating) in embodiments. Due to the formation process for corrosion resistant coatings, complete coverage of the component 405 may be achieved in some embodiments. A thickness of the protective coating may be less than 200 μm, less than 100 μm, less than 50 μm, less than 25 μm, less than 10 μm, less than 5 μm, less than 2 μm, less than 1 μm, less than 750 nm, less than 500 nm, or less than 250 nm according to embodiments. A thickness of the protective coating may be greater than 50 nm, greater than 100 nm, greater than 250 nm, greater than 500 nm, greater than 750 nm, greater than 1 μm, greater than 2 μm, greater than 5 μm, greater than 10 μm, greater than 25 μm, or greater than 50 μm in embodiments. Each of the upper limits may be combined with each of the lower limits to form additional embodiments. For example, the coating thickness may be between 100 nm and 300 nm in some embodiments due to time considerations imposed by electroless plating deposition rates.

The component 405 is textured before formation of the protective coating 420. Protective coating 420 may have improved adhesion to textured surfaces, as formed herein, compared with the untextured alternative. In some embodiments, the texturing may be performed to a depth up to and including the thickness of the protective coating. For example, prior to applying a protective coating, component 405 may be textured by electrochemical anchoring or bead blasting as described in the ensuing examples. The texturing may be performed to a depth of at least 10 nm, at least 25 nm, at least 50 nm, at least 100 nm, at least 250 nm, at least 500 nm, at least 750 nm, at least 1 μm, at least 3 μm or at least 5 μm in embodiments. The surface may be textured to a depth of less than 80 μm, less than 50 μm, less than 25 μm, less than 10 μm, less than 5 μm, less than 2 μm, less than 1 μm, less than 500 nm, less than 200 nm, or less than 100 nm according to embodiments. Each of the upper limits may be combined with each of the lower limits to form additional embodiments. The texturing may not extend to a depth greater than the overall thickness of the protective coating to limit exposure of underlying materials and ensure coverage according to embodiments. The film properties, processing parameters and other process details described in any example herein may be applied to any other example in embodiments. All details may not be included in each example for the sake of brevity.

After texturing by electrochemical anchoring or bead blasting, the textured surface of the aluminum chamber component may have an RMS roughness of at least 100 nm, at least 250 nm, at least 500 nm, at least 1 μm, or at least 3 μm in embodiments. The textured surface may have an RMS roughness of less than 10 μm, less than 6 μm, less than 5 μm, less than 4 μm, less than 3 μm, less than 2 μm, less than 1 μm, less than 750 nm, less than 500 nm, or less than 300 nm according to embodiments. Upper limits may be combined each of the lower limits to form additional embodiments.

Additionally, the apertures may be characterized by a diameter as well as an aspect ratio, which may depend on the profile of the apertures. To provide adequate reduction or elimination of ions in plasma effluents, each aperture may be characterized by a diameter at the narrowest cross section of less than 0.3 inches, less than 0.25 inches, less than 0.2 inches, less than 0.15 inches, less than 0.1 inches, less than 0.05 inches, less than 0.025 inches in embodiments. In some embodiments, or for some components, the narrowest cross section may be greater than 0.1 inches or more to reduce an associated increase in pressure, which may affect process operations as previously described. The aspect ratio may be defined as an aperture height through the component divided by or compared to the diameter at the narrowest cross section of the aperture. In embodiments, the aspect ratio may be greater than, less than, or about 50:1 to reduce a pressure increase across the component. In some embodiments, the aspect ratio may be less than 40:1, less than 30:1, less than 20:1, less than 10:1, less than 5:1 according to embodiments. In some embodiments, the aspect ratio may be maintained greater than 10:1 to ensure adequate control of plasma species. Although the additional examples of FIG. 4 do not illustrate the protective coating, the protective coating may be applied to or present on any of the illustrated apertures.

FIG. 4B illustrates an additional aperture profile for a chamber component 405b, in which each aperture of the plurality of apertures may be characterized by a first section 412b extending from first surface 407b to an interior position, and a second section 414b extending from the interior position to second surface 409b. The two sections may both be straight sections, which may be cylindrical, and may define a ledge between the first section and the second section.

FIG. 4C illustrates an additional aperture profile for a chamber component 405c, in which each aperture of the plurality of apertures may be characterized by a first section 412c characterized by a taper extending from a first surface 407c of component 405c at least partially through the aperture. Each aperture may also be characterized by a second section 414c, which may be a straight or cylindrical section, or characterized by substantially straight sidewalls, at least partially extending through each aperture, such as from first section 412c to second surface 409c of component 405c. First section 412c may be characterized by an angle of taper 413, which may be between about 5° and about 120°. The diameter of first section 412c at first surface 407c may depend on the height of the plate and depth of the first section at the determined angle, and in some embodiments, the diameter of each aperture at first surface 407 may be less than or about 10 mm, although thicker plates, such as greater than or about 4 inches, may be characterized by greater diameters at the first surface. Additionally, second section 414c may be characterized by a diameter 415, which may be any of the diameters previously described. Additionally, in some embodiments the second section 414c may be characterized by a height through the component 405. In some embodiments, the diameter may be equal to or greater than the height, and may be up to twice the height dimension or more.

FIG. 4D illustrates an additional embodiment in which apertures may include a third section through the component 405. As illustrated, component 405d may include apertures having a first section 412d similar to section 412c discussed above and extending from first surface 407e, and a second section 414d similar to section 414c discussed above. The first section 412d and second section 414d may be characterized by similar dimensional characteristics to those described for component 405c. Additionally, apertures of component 405d may include a third section 416d, which may be characterized by a flare. For example, the apertures may include first section 412d extending from first surface 407d to a position intersecting second section 414d. Second section 414d may extend from first section 412d to a position intersecting third section 416d. Third section 416d may extend from second section 414d to second surface 409d of component 405d. Third section 416d may be characterized by an angle of flare, which may be greater than or less than the angle of taper, and may be of any of the angles previously noted. In some embodiments, the angle of flare may be equal to the angle of taper.

FIG. 4E illustrates an additional aperture design. Component 405e may include apertures including a first straight or cylindrical section 410e, which may extend to a second section 412e, and which may be characterized by an angle of taper. Second section 412e may extend to a third section 414e, which may be characterized by a straight or cylindrical profile. Third section 414e may extend to a fourth section 416e, which may extend to second surface 409e of component 405e. It is to be understood that FIG. 4 illustrates only example aperture configurations, and that a variety of additional and alternative aperture designs are similarly encompassed by the present technology.

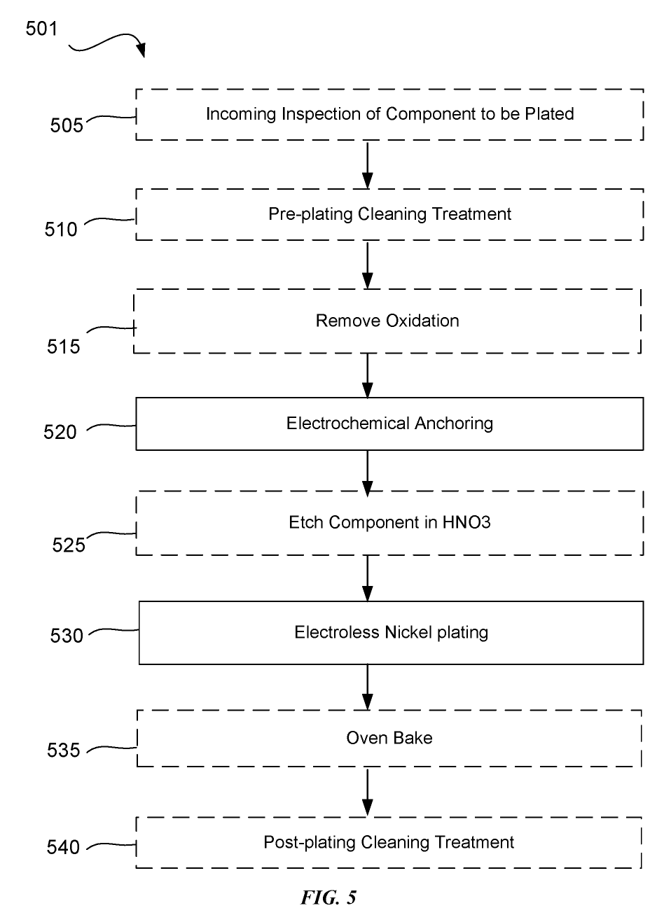

FIG. 5 shows exemplary operations in a method 501 according to embodiments of the present technology. The chamber components coated with the protective coatings formed herein may be used on the chambers discussed previously, for example, during etching processes. The chamber component may be a showerhead having apertures with the dimensions described along with the chambers and in combination with FIGS. 4A-4E. The chamber component may undergo incoming inspection (operation 505) prior to a pre-plating cleaning treatment in operation 510. The pre-plating cleaning treatment may involve submerging the component in a liquid bath. The pre-plating liquid cleaning bath may include one or more of isopropyl alcohol, sodium hydroxide, or potassium hydroxide according to embodiments. Exposure to the pre-plating liquid cleaning bath may assist by removing grease and oil left over from the manufacturing of the aluminum component (e.g. machining). A temperature of the liquid bath in operation 510 may be between −20° C. and 100° C., −15° C. and 75° C., between −10° C. and 50° C., or between 0° C. and 20° C. in embodiments. Operations 505 and 510 are optional as indicated by the dashed border.

Native aluminum oxide may be removed from the aluminum chamber component in optional operation 515. Operation 515 may comprise exposing, submerging, or partially submerging the aluminum chamber component to a liquid bath comprising hydrogen fluoride, hydrofluoric acid, an HF/HNO₃ solution or NaOH. Operation 515 may remove metallic residue, as well, which may be left over from the manufacturing process. Generally speaking, the texturing operations disclosed herein may work on aluminum oxide surfaces in addition to aluminum surfaces, in embodiments. The removal of the native aluminum oxide in operation 515 simply represents one exemplary way of producing a clean component surface which may be textured according to the present technology. According to embodiments, the liquid bath in operation 515 may comprise between 0.5 and 10% HF by volume, and between 1 and 50% HNO₃ by volume. The remainder of the liquid bath may be deionized water in embodiments. A temperature of the liquid bath in operation 515 may be between 0° C. and 90° C., or between 0° C. and 80° C. according to embodiments.

The component may be exposed to an electrochemical anchoring chemical in operation 520. The component is textured or roughened during operation 520 to the extents described elsewhere herein. The texturing may be alternatively referred to as electrochemical anchoring. In operation 520, the chamber component may undergo etching or treatment in a liquid solution comprising or consisting of one of hydrochloric acid, sulfuric acid, oxalic acid, propionic acid, succinic acid and/or glycolic acid according to embodiments. The component may be submerged or partially submerged in a liquid solution containing a chemical selected from HCl, H₂SO₄, C₂H₂O₄, C₂H₅COOH, (CH₂)₂(CO₂H)₂ and/or C₂H₄O₃ according to embodiments.

During operation 520, the electrochemical anchoring chemical may be a liquid electrolytic solution into which the component is partially or wholly immersed according to embodiments. A temperature of the liquid electrolytic solution may be between −20° C. and 120° C., between −10° C. and 110° C., between 0° C. and 100° C., between 10° C. and 90° C., or between 20° C. and 80° C. in embodiments. The component may be submerged for a duration between 10 seconds and 30 minutes or between 30 seconds and 15 minutes according to embodiments. In a preferred embodiment, the liquid solution is an oxalic acid which has been found to produce a advantageously ordered electrochemical anchoring matrix on the surface of the aluminum chamber component. A voltage may be applied across the liquid electrolytic solution to produce the texturing on the chamber component which produces the electrochemical anchoring to more firmly affix the electroless nickel plating to the component. The voltage may be applied between the component and an anode. A resulting current flows across the liquid electrolytic solution during operation 520. The voltage may be between 0.1 volts and 500 volts, between 0.2 volts and 300 volts, between 0.3 volts and 50 volts or between 0.5 volts and 10 volts according to embodiments. The current may be between 0.01 milliamps and 500 milliamps, between 0.02 milliamps and 50,000 milliamps, between 0.03 milliamps and 10,000 milliamps, between 0.05 milliamps and 500 milliamps or between 0.1 milliamps and 10 milliamps according to embodiments.

In any liquid treatment described herein, the component may more generally be exposed to the liquid such that all portions of the component (which will ultimately be exposed to chemistry within the substrate processing chamber) are exposed to the liquid treatments.

In optional operation 525, the chamber component may undergo etching in a solution of one or more of nitric acid, potassium hydroxide, and/or sodium hydroxide. The component may be submerged or partially submerged in a liquid solution containing an etchant chemical selected from HNO₃, KOH, H₃PO₄, H₂SO₄ and/or NaOH according to embodiments. The liquid solution may comprise or consist of nitric acid, potassium hydroxide, phosphoric acid, sulfuric acid or sodium hydroxide in embodiments. The pre-plating cleaning treatment may involve submerging the component in a liquid bath. During operation 525, the temperature of the liquid solution may be between −20° C. and 50° C., between −10° C. and 40° C., or between 0° C. and 20° C. in embodiments. The component may be submerged for a duration between 30 seconds and 120 minutes or between 1 minute and 60 minutes according to embodiments.

The chamber component is coated with a protective coating during operation 530. The protective coating comprises nickel and may be applied by an electroless method according to embodiments. The process of applying the protective coating of nickel may be referred to electroless nickel plating (ENP) and may occur in a nickel-containing liquid solution. The nickel plating process may involve no or essentially no applied voltage across (or current through) the nickel-containing liquid solution in embodiments. There may be no zinc (or lead or tin) layer to promote adhesion between the protective coating and the chamber component, according to embodiments, as the texturing/electrochemical anchoring may be sufficient to satisfactorily affix the nickel coating to the chamber component. Conventional ENP involves application of a relatively thick zinc layer. There may be no adhesion layer at all between the nickel coating and the chamber component and the nickel coating may be in direct contact with the aluminum or aluminum oxide in embodiments. A thin adhesion layer (e.g. a zinc layer) may be included to assist the bonding between the chamber component and the nickel coating, according to embodiments, as the metal contamination has been found to be beneficially reduced for thin zinc layers as recited explicitly in the next example. The protective coating may optionally be heated (operation 535) and cleaned (operation 540) according to embodiments.

The nickel-containing liquid solution may comprise a source of nickel, water, and a reducing agent such as NaPO₂H₂. The protective coating may comprise nickel and may comprise or consist of nickel and phosphorus in embodiments. The protective coating may comprise between 3% and 16% phosphorus by weight, between 7% and 15% phosphorus by weight, or between 9% and 14% phosphorus by weight according to embodiments. The protective coating may comprise between 10% and 13% phosphorus by weight to improve corrosion resistance and reduce surface porosity. The balance of the protective coating may be nickel.

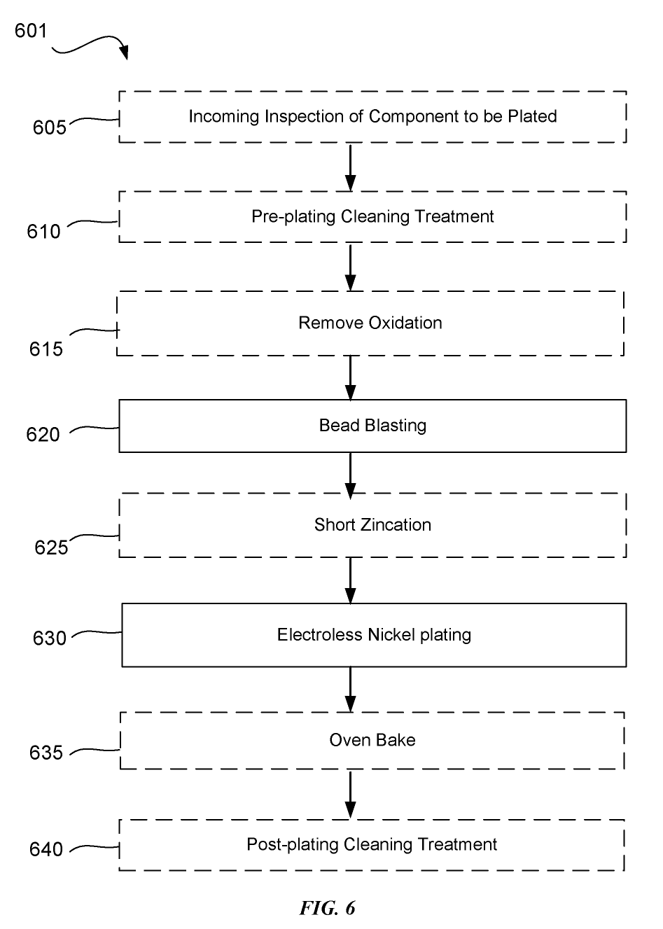

FIG. 6 shows exemplary operations in a method 601 according to embodiments of the present technology. The specifics of the previous method 501 may apply here as well, in embodiments, and will generally not be repeated for the sake of brevity. The chamber component may be a showerhead having apertures with the dimensions described elsewhere herein. The chamber component may undergo incoming inspection (optional operation 605) prior to a pre-plating cleaning treatment (optional operation 610) and a removal of aluminum oxide from the aluminum chamber component (optional operation 615). The component may be bead blasted in operation 620. The component is textured or roughened during operation 620 to the extents described elsewhere herein. The beads may be formed of silicon carbide, aluminum oxide or silicon oxide according to embodiments. The beads may be spherical and may have average diameters in the range between 100 nm and 50 μm, between 200 nm and 25 μm, between 500 nm and 10 μm, or between 1 μm and 5 μm. Following texturing by any of the means discussed herein, the aluminum chamber component may optionally be etched in nitric acid at this point (not shown).

The component may have no adhesion layer or a thin adhesion layer applied (optional operation 625). A zinc, lead or tin layer may be applied to promote the adhesion of an electroless nickel plating layer. A thin zinc layer may be formed on the chamber component in a process which may be referred to as zincation. The optional thin adhesion layer in combination with the texturing may combine to firmly affix the nickel coating to the chamber component. Conventional ENP involves application of a relatively thick zinc layer to promote adhesion and undesirable metal contamination (e.g. zinc, lead, or tin) may redistribute onto a substrate especially during an aggressive etch process. The thin adhesion layer may be less than 5 μm, less than 2 μm, less than 1 μm, less than 500 nm, less than 200 nm, less than 100 nm, less than 50 nm, less than 20 nm or less than 10 nm according to embodiments. The upper limits may be combined with the following lower limits to form additional embodiments. The thin adhesion layer may be greater than 2 nm, greater than 5 nm, greater than 7 nm, greater than 10 nm, greater than 20 nm or greater than 50 nm according to embodiments. In some embodiments, no adhesion layer is placed between the nickel coating and the chamber component and the nickel coating may be in direct contact with the textured aluminum or aluminum oxide in embodiments. The chamber component may be etched following optional operation 625 in a liquid bath comprising, for example, HNO₃, KOH, and/or NaOH as before (not shown).

The chamber component is coated with a protective coating during operation 630. The protective coating comprises nickel and may be applied by an electroless method according to embodiments. The process of applying the protective coating of nickel may occur in a nickel-containing liquid solution as described previously. The nickel plating process may involve no or essentially no applied voltage across (or current through) the nickel-containing liquid solution in embodiments. The chamber component and the protective coating may optionally be heated (operation 635) and cleaned (operation 640) according to embodiments.

Texturing a chamber component by electrochemical anchoring or bead blasting may each be used for aluminum components which have no features or have features such as apertures. In some embodiments, texturing by electrochemical anchoring may be preferred for chamber components which have any features, especially intricate features such as large aspect ratio through-holes in aluminum showerheads as described herein. Large aspect ratio apertures of aluminum showerheads may not be uniformly textured by bead blasting which, in turn, may lead to unevenly adhered nickel protective plating. Aluminum chamber components having planar surfaces may be textured by electrochemical anchoring or bead blasting according to embodiments.

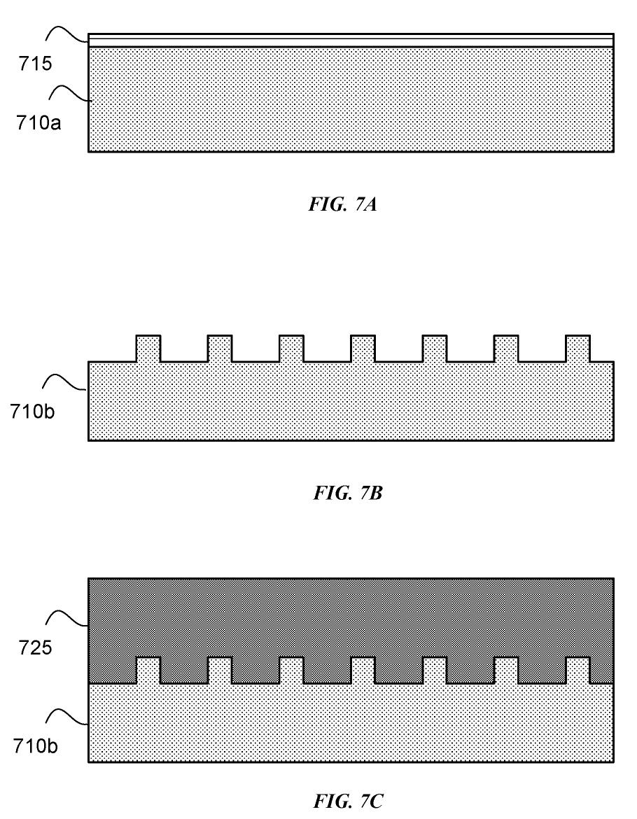

FIGS. 7A-7C illustrate schematic cross-sectional views of exemplary protective coatings that may be formed on a chamber component according to some embodiments of the present technology. An aluminum chamber component 710a has a layer of aluminum oxide 715 on top and the aluminum oxide layer 715 is removed before plating begins (see FIG. 7A). FIG. 7B shows the aluminum chamber component 710b after the aluminum oxide layer 715 is removed and also after texturing, for example, by electrochemical anchoring in operation 520 or bead blasting in operation 620. FIG. 7C shows the aluminum chamber component 710b along with a protective coating 725 of nickel deposited by electroless nickel plating (e.g. operations 530 and 630).

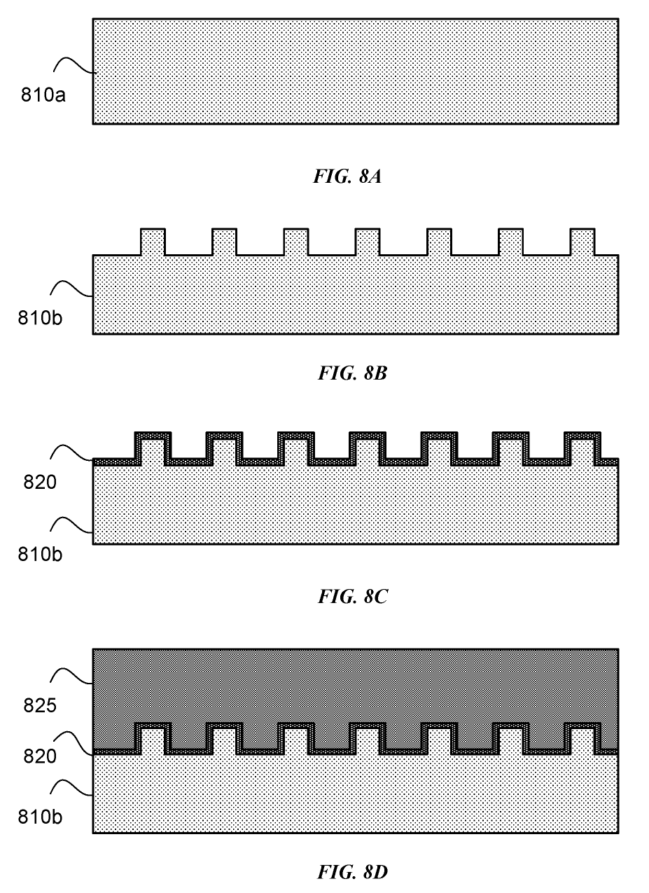

FIGS. 8A-8D illustrate schematic cross-sectional views of exemplary protective coatings that may be formed on a chamber component according to some embodiments of the present technology. In this example, an aluminum chamber component 810a is shown in FIG. 8A without an overlying layer of aluminum oxide. In embodiments, any oxidation layer is removed before texturing or plating begins. FIG. 8B shows the aluminum chamber component 810b after texturing, for example, by electrochemical anchoring in operation 520 or bead blasting in operation 620. FIG. 8C shows the aluminum chamber component after zincation (e.g. operation 625) to form a thin zinc layer (more generally an adhesion layer 820). FIG. 8D shows the aluminum chamber component 810b along with a protective coating 825 of nickel deposited by electroless nickel plating (e.g. operations 530 and 630) on top of the adhesion layer 820.

The protective coating 825 and the optional adhesion layer 820 may each be described as conformal in the processes described. As used herein, a conformal layer refers to a generally uniform layer of material on a surface in the same shape as the surface, i.e., the surface of the layer and the surface being covered are generally parallel. A person having ordinary skill in the art will recognize that the deposited material likely cannot be 100% conformal and thus the term “generally” allows for acceptable tolerances. The optional conformal adhesion (e.g. zinc) layer may be thinner than conventional adhesion layers beneath conventional nickel layers. The conformal adhesion layer may be conformal on the length scale of the texture applied to the surface of the aluminum components as well as conformal relative to the dimensions of any apertures of the aluminum components. On the other hand, the nickel layer may be described as conformal on the length scale of any apertures present in the aluminum components but will likely not be conformal on the length scale of the texture applied, according to embodiments.

By forming the protective coating on chamber components as described throughout, reduced contamination may occur on substrates being processed. For example, in embodiments of the present technology using protective coatings on one or more chamber components discussed, undesireable metal contamination redistributed from the semiconductor chamber components onto a surface of a wafer or substrate may be reduced. As a consequence of the methods described herein, elemental metal contamination (e.g. Zn, Pb, or Sn) may be less than 10E10 atoms/cm², less than 7E10 atoms/cm², less than 5E10 atoms/cm², less than 4E10 atoms/cm², less than 3E10 atoms/cm², less than 2E10 atoms/cm², less than 1E10 atoms/cm², less than 0.5E10 atoms/cm² or less than 0.05E10 atoms/cm², according to embodiments. Particle performance may also be improved as a consequence of implementing the present technology. In embodiments, wafer-level particle contribution sizes of 65 nm, 35 nm, and 20 nm and less may be reduced. For example, in embodiments of the present technology using nickel coatings on one or more chamber components discussed, wafer-level particle contribution of 35 nm size from the semiconductor chamber components may be reduced to less than 100 adders, and may be reduced to less than 50 adders, less than 20 adders, less than 10 adders, less than 5 adders, less than 2 adders, or less than 1 adder. Consequently, the present technology may improve device production, while additionally increasing component life within the processing chamber.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology. Additionally, methods or processes may be described as sequential or in steps, but it is to be understood that the operations may be performed concurrently, or in different orders than listed.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

As used herein and in the appended claims, the singular forms “a”, “an”, and “the” include plural references unless the context clearly dictates otherwise. Thus, for example, reference to “a precursor” includes a plurality of such precursors, and reference to “the layer” includes reference to one or more layers and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

1. A method of coating a showerhead, the method comprising:
removing aluminum oxide from the showerhead, wherein removing the aluminum oxide exposes aluminum portions of the showerhead and wherein the showerhead comprises through-holes extending from a top of the showerhead to a bottom of the showerhead;
electrochemically anchoring the aluminum portions of the showerhead by exposing the showerhead to an electrochemically anchoring chemical; and
forming a nickel layer on the aluminum portions.

2. The method of claim 1, wherein the electrochemically anchoring chemical comprises at least one of hydrochloric acid, sulfuric acid, oxalic acid, propionic acid, succinic acid, glycolic acid, or an organic acid.

3. The method of claim 1, wherein exposing the showerhead to the electrochemically anchoring chemical comprises submerging the showerhead in a liquid bath.

4. The method of claim 3, wherein a temperature of the liquid bath is between −20° C. and 120° C.

5. The method of claim 1, wherein the nickel layer consists of nickel or consists of nickel and phosphorus.

6. The method of claim 1, further comprising forming an adhesion layer after electrochemically anchoring the aluminum portions and before forming the nickel layer.

7. The method of claim 6, a thickness of the adhesion layer is less than 5 μm.

8. The method of claim 1, wherein no adhesion layer is included between the aluminum portions and the nickel layer.

9. A method of coating a component of a semiconductor processing chamber, the method comprising:
texturing an exposed surface of the component, wherein the component defines a plurality of apertures including a taper extending at least partially through a first section of each aperture of the plurality of apertures, and wherein the taper is characterized by an angle of taper through the first section of each aperture of the plurality of apertures; and
applying a protective coating onto the component, wherein the protective coating comprises nickel and phosphorus.

10. The method of claim 9, wherein the exposed surface of the component is aluminum or aluminum oxide.

11. The method of claim 9, wherein a thickness of the protective coating is less than 200 μm.

12. The method of claim 11, wherein texturing the exposed surface is performed to a depth of at least 10 nm.

13. The method of claim 9, wherein the protective coating comprises nickel and phosphorus and comprises between 3% and 16% phosphorus by weight.

14. A method of coating a showerhead, the method comprising:
removing aluminum oxide from the showerhead, wherein removing the aluminum oxide exposes aluminum portions of the showerhead and wherein the showerhead comprises apertures extending from a top of the showerhead to a bottom of the showerhead;
electrochemically anchoring the aluminum portions of the showerhead by exposing the showerhead to an electrochemically anchoring chemical in a liquid bath;
applying a voltage between the showerhead and an anode, wherein the showerhead and the anode are disposed within the liquid bath;
texturing the aluminum portions of the showerhead;
electroless nickel plating a nickel layer onto the aluminum portions of the showerhead.

15. The method of claim 14, wherein the voltage is between 0.1 volts and 500 volts.
